(19) United States
(12) Patent Application Publication
(10) Pub. No.: US 2006/0113764 A1
(43) Pub. Date: Jun. 1, 2006

(54) VEHICLE SEAT ASSEMBLY

(75) Inventor: Michael L. Tracht, Ingolstadt (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/904,840

(22) Filed: Dec. 1, 2004

(51) Int. Cl. B60R 21/22; B60R 21/16

(52) U.S. Cl. 280/730.2

(57) ABSTRACT

A vehicle seat assembly includes a frame for mounting the seat to a vehicle. The seat assembly also includes a seat pad molded from a polymeric material and located proximate the frame. A trim cover is disposed over the seat pad, and includes a seam adjacent a side of the seat pad. An airbag assembly, which includes an airbag and an inflator configured to supply gas to the airbag, is also part of the seat assembly. A pad shield is molded in situ with the seat pad, and covers at least a portion of the seat pad for protecting it during deployment of the airbag. The pad shield includes first and second portions which form a deployment channel for the airbag, and thereby inhibit contact of the airbag with the seat pad as the airbag deploys.

### BACKGROUND OF THE INVENTION

1. Field of the Invention

The present invention relates to a vehicle seat assembly, and in particular, a seat assembly including an airbag.

2. Background Art

Vehicles today are increasingly equipped with side airbags, which may be in the form of a side air curtain disposed in a headliner of the vehicle, or alternatively, may be an airbag disposed within a vehicle seat assembly. One limitation of airbags that are located within a seat assembly, is that the airbag needs to break through the seating material before it can fully deploy to protect a vehicle occupant. During deployment, such an airbag may encounter foam, or other seat pad materials, and must then break through a seat trim cover in order to escape from the seat assembly.

A number of attempts have been made to facilitate deployment of airbags from and through a vehicle seat assembly. One such device is described in U.S. Pat. No. 5,816,610 issued to Higashiura et al. on Oct. 6, 1998. Higashiura et al. describes a seat structure having a side impact airbag apparatus. A seat back pad of the seat structure may be made from foam, in which case the airbag apparatus is surrounded by a lining member. The lining member has a perforation to facilitate its breaking when the airbag deploys. The seat back itself is covered with a surface layer having a seam almost directly opposite the perforation in the lining member. In this way, the airbag deploys through the perforation in the lining member, breaks through the foam of the seat pad, and exits the seat structure through the seam in the surface layer. One limitation of the seat structure described in Higashiura et al., is that the airbag must deploy through the seat pad prior to exiting the seat structure. In particular, the airbag, which may be moving with very high velocity, impacts the foam seat pad as it exits the seat structure. This can cause pieces of the seat pad to be expelled from the seat as the airbag exits the seat cover. Therefore, a need exists for a seat assembly that includes protection for the seat pad from the deploying airbag.

### SUMMARY OF THE INVENTION

Accordingly, the present invention provides a vehicle seat assembly including a seat pad, and a pad shield configured to protect the seat pad during deployment of an airbag from within the seat assembly.

The invention also provides a pad shield molded in situ with the seat pad, thereby providing for accurate locating of the pad shield, and eliminating a post-molding assembly operation.

The invention further provides a vehicle seat assembly including a frame for mounting the seat to the vehicle. A seat pad includes a molded polymeric material, and is disposed proximate the frame. A trim cover is disposed over the seat pad, and includes a seam adjacent a side of the seat pad. An airbag assembly is provided, which includes an airbag and an inflator which is configured to supply gas to the airbag, thereby facilitating deployment of the airbag. A pad shield is molded in situ with the seat pad, and covers at least a portion of the seat pad for protecting the seat pad during deployment of the airbag. The pad shield includes first and second portions forming a deployment channel therebetween for the airbag, thereby inhibiting contact of the airbag with the seat pad during deployment of the airbag.

The invention also provides a vehicle seat assembly, including a frame for mounting the seat to a vehicle. A seat pad includes a molded polymeric material disposed proximate the frame. A trim cover is disposed over the seat pad, and includes a seam adjacent a side of the seat pad. An airbag assembly is also provided, and includes an airbag and an inflator configured to supply gas to the airbag, thereby facilitating deployment of the airbag. A pad shield is molded in situ with the seat pad, and covers at least a portion of the seat pad for protecting the seat pad during the deployment of the airbag. The pad shield includes two separate portions cooperating with each other to form a deployment channel therebetween for the airbag such that deployment of the airbag along the deployment channel moves a portion of the seat pad away from the deploying airbag, while the pad shield inhibits contact between the seat pad and the deploying airbag. The orientation of the deployment channel facilitates deployment of the airbag through the seam in the trim cover.

The invention further provides a vehicle seat assembly, including a frame for mounting the seat to a vehicle, and a seat pad including a molded polymeric material. The seat pad is disposed proximate the frame. A trim cover is disposed over the seat pad, and includes a seam adjacent a side of the seat pad. An airbag assembly is also provided, and includes an airbag disposed at least partially within an airbag housing, and an inflator configured to supply gas to the airbag, thereby facilitating deployment of the airbag. A blocking member is molded in situ with the seat pad, and is configured to form a barrier on at least two sides of the airbag, thereby prohibiting contact between the airbag and the seat pad during the deployment of the airbag.

### BRIEF DESCRIPTION OF THE DRAWINGS

FIG. 1 is a fragmentary side view of a portion of a seat assembly in accordance with the present invention;

FIG. 2 is a fragmentary sectional view of the seat assembly shown in FIG. 1, taken through line 2-2; and

FIG. 3 is a fragmentary sectional view of a detail of the seat assembly shown in FIG. 2.

### DETAILED DESCRIPTION OF THE PREFERRED EMBODIMENT(S)

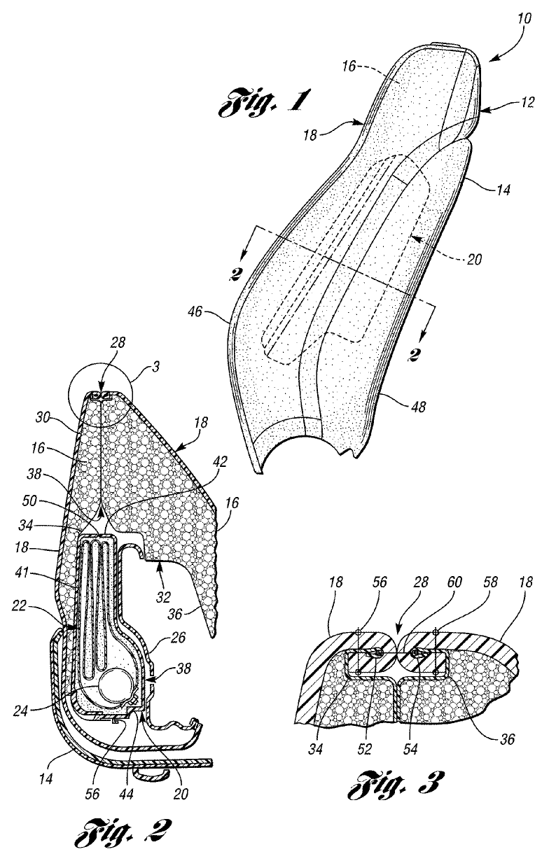

FIG. 1 shows a portion of a seat assembly 10 in accordance with the present invention. The seat assembly 10 includes a seat back 12, a back panel 14, and seat pad 16 covered by a trim cover 18. The seat pad 16 is made from a molded polymeric material, such as a polyurethane foam. The use of a polymeric foam material to construct the seat pad 16 is cost effective and provides the flexibility needed to easily change the shape of the seat pad for different types of seat assemblies. Of course, other types of polymeric materials may be molded to form a seat pad, such as the seat pad 16.

Disposed within the seat back 12 is an airbag assembly 20. As shown in FIG. 2, the airbag assembly 20 includes an airbag 22 and an inflator 24, which is configured to supply gas to the airbag 22, thereby facilitating deployment of the airbag 22. Also shown in FIG. 2 is a portion of a seat frame 26 which can be used for mounting the seat assembly 10 to a vehicle. The seat pad 16 is disposed proximate the frame 26 and may be directly attached to the frame 26 at various points. The trim cover 18 includes a seam 28 which is adjacent to a side 30 of the seat pad 16. Covering at least a portion of the seat pad 16 is a pad shield 32. As explained more fully below, the pad shield 32 protects the seat pad 16 during deployment of the airbag 22.

The pad shield 32 may be made from any material effective to protect the seat pad 16 during deployment of the airbag 22. For example, a woven or non-woven cloth material, which may include natural or synthetic materials such as nylon. One material that is found to be effective is a polyester material, of the type from which the airbag 22 may be manufactured. Regardless of the type of material used to make the pad shield 32, the use of the pad shield 32 can reduce friction on the airbag 22 as it deploys. Although a polymer such as nylon may be particularly beneficial, even a fleece material will help reduce the friction on the airbag 22. This is because the pad shield 32 inhibits contact between the deploying airbag 22 and the seat pad 16. In the embodiment shown in FIG. 2, the pad shield 32 is effective to prohibit all contact between the deploying airbag 22 and the seat pad 16. This helps to prevent energy loss from the airbag 22 by decreasing friction and protecting the seat pad 16 from damage. This, in turn, helps to reduce the deployment time for the airbag 22.

The pad shield 32 is molded in situ with the seat pad 16—i.e., the pad shield 32 is placed in a mold and the foam seat pad 16 is formed around it. This provides a number of advantages over typical assembly methods which may include placing a material in a seat pad after the foam has been molded. For example, molding the pad shield 32 in situ helps to ensure that it will be accurately located to provide maximum protection for the seat pad 16. Moreover, the use of an additional adhesive can be eliminated, as the foam material used for the seat pad 16 will naturally adhere to the pad shield 32. In the embodiment shown in FIG. 2, the additional step of placing material within a seat assembly is also eliminated—i.e., the pad shield 32 is installed at the same time the seat pad 16 is installed.

The pad shield 32 includes first and second portions 34, 36 which form a deployment channel 38 for the airbag 22. When the pad shield 32 is placed in the mold to form the seat pad 16, some of the first and second portions 34, 36 are located immediately adjacent each other for some predetermined length. This forms the deployment channel 38, shown in FIG. 2. As the airbag 22 deploys through the deployment channel 38, the pad shield 32 acts as a blocking member that forms a barrier on two sides 39, 41 of the airbag 22, thereby inhibiting contact between the airbag 22 and the seat pad 16. Thus, the seat pad 16 is moved away from the airbag 22 as it deploys through the deployment channel 38.

As shown in FIG. 2, the deployment channel 38 is oriented to facilitate deployment of the airbag 22 through the seam 28 in the trim cover 18. In particular, the airbag assembly 20 includes a housing 40 which at least partially surrounds the airbag 22 and the inflator 24. The housing 40 includes a front 42 and a back 44 which are generally oriented toward a front 46 and back 48 of the seat assembly 10—see also FIG. 1. The front 42 of the housing 40 includes a frangible portion 50 which is easily broken by the airbag 22 as it deploys. The frangible portion 50 is disposed opposite the deployment channel 38 to facilitate deployment of the airbag along the channel 38 and out the seam 28. Although the airbag housing 40 comprises a relatively rigid material, in other embodiments, a thin sheet of material may be used in place of a rigid housing. In such embodiments, the sheet need not contain a frangible portion, as its properties will be such that it will tear as the airbag 22 deploys.

As shown in FIG. 3, the first and second portions 34, 36 of the pad shield 32 respectively include ends 52, 54 attached to the trim cover 18 at the seam 28. This configuration helps to facilitate deployment of the airbag 22 through the seam 28. This is because the deployment channel 38 opens as the airbag 22 is deployed, and this causes first and second portions 34, 36 to exert an outward force on the trim cover 18 at the seam 28; this helps to open the seam 28 to provide an easy exit for the airbag 22. As shown in FIG. 3, the seam 28 is sewn at locations 56, 58, where the ends 52, 54 of the pad shield 32 are captured between portions of the trim cover 18. The seam 28 can also be sewn at location 60, where ends of the trim cover 18 are sewn together with the pad shield 32. This helps to transfer the force from the pad shield 32, and facilitates separation of the seam 28.

Although a pad shield, such as the pad shield 32, may be a unitary structure, it may also consist of two separate panels 34, 36, such as shown in FIGS. 2 and 3. In the embodiment shown in FIG. 3, the end 52 of the first portion 34 of the pad shield 32 is attached at the seam 28 of the trim cover 18. A second end 56 of the first portion 34 of the pad shield 32 is attached to the back 44 of the airbag housing 38, between the seat frame 26 and the airbag housing 38—see FIG. 2. This provides a convenient means for securely attaching the first portion 34 of the pad shield 32. Similarly, the end 54 of the second portion 36 of the pad shield 32 is attached at the seam 28 of the trim cover 18—see FIG. 3. Although not shown in the drawing figures, a second end of the second portion 36 of the pad shield 32 may be attached to a secure location within the seat assembly 10, such as a point on the seat frame 26. Thus, the pad shield 32 not only provides a deployment channel for the airbag 22, but also protects the seat pad 16 from damage during the high velocity deployment. Moreover, because the pad shield 32 is molded in situ with the seat pad 16, it is accurately located and can be produced cost effectively.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly, comprising:
a frame for mounting the seat assembly to a vehicle;
a seat pad including a molded polymeric material disposed proximate the frame;
a trim cover disposed over the seat pad and including a seam adjacent a side of the seat pad;
an airbag assembly, including an airbag and an inflator configured to supply gas to the airbag, thereby facilitating deployment of the airbag; and
a pad shield molded in situ with the seat pad and covering at least a portion of the seat pad for protecting the seat pad during the deployment of the airbag, the pad shield including first and second portions forming a deployment channel therebetween for the airbag.

2. The vehicle seat assembly of claim 1, wherein the deployment channel is oriented to facilitate deployment of the airbag through the seam in the trim cover.

3. The vehicle seat assembly of claim 1, wherein the first and second portions of the pad shield each include an end attached to the trim cover at the seam.

4. The vehicle seat assembly of claim 1, wherein the airbag assembly includes a housing at least partially surrounding the airbag and including a front generally oriented toward a front of the seat assembly, and a back generally oriented toward a back of the seat assembly, the front of the housing including a frangible portion disposed to facilitate deployment of the airbag along the deployment channel.

5. The vehicle seat assembly of claim 4, wherein the first and second portions of the pad shield are separate panels which come together to form the deployment channel opposite the front of the airbag housing.

6. The vehicle seat assembly of claim 5, wherein the first portion of the pad shield includes a first end attached to the trim cover at the seam, and a second end attached to the airbag housing.

7. A method of producing the vehicle seat assembly of claim 1, comprising:
placing the pad shield in a mold such that the first and second portions of the pad shield are disposed immediately adjacent each other along a predetermined length;
molding a polymeric material around the pad shield to form the seat pad with the pad shield attached thereto;
disposing the seat pad and pad shield proximate the air bag assembly such that the airbag will deploy along the predetermined length;
disposing the trim cover over the seat pad;
attaching an end of the first portion of the pad shield to the seam in the trim cover; and
attaching an end of the second portion of the pad shield to the seam in the trim cover.

8. A vehicle seat assembly, comprising:
a frame for mounting the seat assembly to a vehicle;
a seat pad including a molded polymeric material disposed proximate the frame;
a trim cover disposed over the seat pad and including a seam adjacent a side of the seat pad;
an airbag assembly, including an airbag and an inflator configured to supply gas to the airbag, thereby facilitating deployment of the airbag; and
a pad shield molded in situ with the seat pad and covering at least a portion of the seat pad for protecting the seat pad during deployment of the airbag, the pad shield including two separate portions cooperating with each other to form a deployment channel therebetween for the airbag such that deployment of the airbag along the deployment channel moves a portion of the seat pad away from the deploying airbag, while the pad shield inhibits contact between the seat pad and the deploying airbag, the orientation of the deployment channel facilitating deployment of the airbag through the seam in the trim cover.

9. The vehicle seat assembly of claim 8, wherein the first and second portions of the pad shield each include an end attached to the trim cover at the seam.

10. The vehicle seat assembly of claim 8, wherein the airbag assembly includes a housing at least partially surrounding the airbag and including a front generally oriented toward a front of the seat assembly, and a back generally oriented toward a back of the seat assembly, the front of the housing including a frangible portion disposed to facilitate deployment of the airbag along the deployment channel.

11. The vehicle seat assembly of claim 10, wherein the first and second portions of the pad shield come together to form the deployment channel opposite the front of the airbag housing.

12. The vehicle seat assembly of claim 11, wherein the first portion of the pad shield includes a first end attached to the trim cover at the seam, and a second end attached to the airbag housing.

13. A vehicle seat assembly, comprising:
a frame for mounting the seat assembly to a vehicle;
a seat pad including a molded polymeric material disposed proximate the frame;
a trim cover disposed over the seat pad and including a seam adjacent a side of the seat pad;
an airbag assembly, including an airbag disposed at least partially within an airbag housing, and an inflator configured to supply gas to the airbag, thereby facilitating deployment of the airbag; and
a blocking member molded in situ with the seat pad and configured to form a barrier on at least two sides of the airbag, thereby prohibiting contact between the airbag and the seat pad during deployment of the airbag.

14. The vehicle seat assembly of claim 13, wherein the blocking member includes a cloth material.

15. The vehicle of claim 13, wherein the blocking member includes a polymeric material.

16. The vehicle seat assembly of claim 13, wherein the blocking member includes first and second portions cooperating to form a deployment channel oriented to facilitate deployment of the airbag through the seam in the trim cover.

17. The vehicle seat assembly of claim 16, wherein the first and second portions of the blocking member each include an end attached to the trim cover at the seam.

18. The vehicle seat assembly of claim 16, wherein the airbag assembly includes a housing at least partially surrounding the airbag and including a front generally oriented toward a front of the seat assembly, and a back generally oriented toward a back of the seat assembly, the front of the housing including a frangible portion disposed to facilitate deployment of the airbag along the deployment channel.

19. The vehicle seat assembly of claim 18, wherein the first and second portions of the blocking member come together to form the deployment channel opposite the front of the airbag housing.

20. The vehicle seat assembly of claim 18, wherein the first portion of the blocking member includes a first end attached to the trim cover at the seam, and a second end attached to the airbag housing.
